(19) United States
(12) Patent Application Publication
(10) Pub. No.: US 2026/0122506 A1
(43) Pub. Date: Apr. 30, 2026

(54) SUB-BLOCK (SB) CONFIGURATION SETTING METHOD, FREQUENCY BAND SELECTION METHOD, AND RELATED APPARATUS

(71) Applicant: Morelink Technology Corporation, Taipei City (TW)

(72) Inventors: Yung-ting LEE, Taipei City (TW); Chunn-yenn LIN, Taipei City (TW)

(21) Appl. No.: 18/930,040

(22) Filed: Oct. 29, 2024

(51) Int. Cl. H04W 16/10; H04W 16/26

(52) U.S. Cl. CPC H04W 16/10; H04W 16/26

(57) ABSTRACT

Provided is a method of setting sub-block (SB) configuration and related apparatus. With this method, a convenient way can be provided to configure or reconfigure the sub-block's center frequency and bandwidth for a repeater by using an auxiliary device to obtain the center frequency and bandwidth of the sub-block available to an operator in a frequency band from a pre-defined look-up table (LUT) based on location information of the auxiliary device. In another aspect, by prioritizing a plurality of available frequency bands based on corresponding quality scores, most appropriate frequency band(s) can be utilized on the repeater to increase the throughput and coverage area of the repeater.

### TECHNICAL FIELD

The present application relates to wireless communication technologies, and more particularly to a method of setting sub-block (SB) configuration, a method of frequency band selection, and related apparatus.

### BACKGROUND

In wireless communication systems, signals are exchanged between a base station (e.g., a cell tower, or gNB in 5G NR (New Radio)) and one or more mobile terminals or user equipments (UEs). The base station can provide services within a coverage area, which may be expanded by a use of repeaters. The repeaters can improve the quality of wireless communication by receiving, filtering, amplifying and re-transmitting the signals communicated between the base station and the one or more UEs in both an uplink (UL) direction (i.e., from the UE to the base station) and a downlink (DL) direction (i.e., from the base station to the UE).

In the telecommunications field, the spectrum is a finite resource, typically managed by government regulatory bodies. Mobile network operators have to obtain licenses to operate within certain frequency ranges. The spectrum is divided into different frequency bands, each covering a specific frequency range. For a specific frequency band (e.g., n78 in 5G NR), an operator may be assigned one or multiple sub-blocks and the one or multiple sub-blocks are merged within the band to increase network capacity and speeds. The merged sub-blocks assigned to the operator determines the bandwidth available to the operator in that band.

For a repeater to operate, a user or a technician has to set the center frequency and bandwidth of a sub-block available to an operator in a band. When the operator obtains two sub-blocks that are separated apart in the band, it may have to decide the signals of which sub-block the repeater should amplify and forward. Furthermore, a sub-block assigned to an operator in a state or a country may differ from that assigned in another state or another country. The user or technician may have to reconfigure the repeater to allocate a correct center frequency and bandwidth of the sub-block based on the installation location of the repeater. This will become more often particularly when the user moves the installation location of the repeater to an adjacent state or country. Moreover, if a repeater is designed to be worldwide applied, a convenient way to set the sub-block's center frequency and bandwidth will be needed. Therefore, how to provide a convenient way to configure or reconfigure the sub-block's center frequency and bandwidth for a repeater is a problem that needs to be solved.

In addition, conventional repeaters can only be operated in one or more fixed frequency bands. That is, supported frequency bands by the repeaters are limited, and during repeater operation, the frequency bands that can be utilized are fixed. When cell quality changes, it is unable to select appropriate frequency band(s) for the repeater. This may limit the throughput performance of the repeater, and the coverage area of the repeater may be limited also. With the development of software-defined radio (a.k.a SDR) technology, novel repeaters are designed to support different frequency bands through the use of common hardware platforms. Therefore, how to provide a convenient frequency band selection and setting method for SDR repeaters is a problem that needs to be solved.

### SUMMARY

In a first aspect, the present application provides a method of setting sub-block (SB) configuration for a repeater, including obtaining, by an auxiliary device, location information of the auxiliary device, wherein the auxiliary device is able to connect to a same mobile network as a repeater; obtaining, by the auxiliary device, center frequency and bandwidth of a sub-block available to an operator in a frequency band from a pre-defined look-up table (LUT) based on the obtained location information; obtaining, by the repeater, the center frequency and bandwidth of the sub-block from the auxiliary device; and setting, by the repeater, a sub-block (SB) configuration by using the obtained center frequency and bandwidth of the sub-block.

In a second aspect, the present application provides a system for setting sub-block (SB) configuration, including: an auxiliary device, including a memory and a first processor coupled to the memory, the first processor being configured to obtain location information of the auxiliary device, wherein the auxiliary device is able to connect to a same mobile network as a repeater; and obtain center frequency and bandwidth of a sub-block available to an operator in a frequency band from a pre-defined look-up table (LUT) based on the obtained location information, and the repeater, including a Rx circuit, a Tx circuit, and a second processor, coupled to the Rx circuit and the Tx circuit, the second processor being configured to obtain the center frequency and bandwidth of the sub-block from the auxiliary device; and set a sub-block (SB) configuration by using the obtained center frequency and bandwidth of the sub-block.

In a third aspect, the present applicant provides a method of frequency band selection by a repeater, including obtaining quality scores corresponding to a plurality of frequency bands if one or more conditions are satisfied, wherein each of the quality score is for one frequency band, and the quality score is resulted from cell quality measurement for the frequency band; prioritizing the plurality of frequency bands based on the obtained quality scores; and selecting at least one frequency band with higher priority from the plurality of frequency bands for being utilized on the repeater to amplify and forward signals.

In a fourth aspect, the present applicant provides a repeater, including a Rx circuit; a Tx circuit; and at least one processor, coupled to the Rx circuit and the Tx circuit, the at least one processor being configured to obtain quality scores corresponding to a plurality of frequency bands if one or more conditions are satisfied, wherein each of the quality score is for one frequency band, and the quality score is resulted from cell quality measurement for the frequency band; prioritize the plurality of frequency bands based on the obtained quality scores; and select at least one frequency band with higher priority from the plurality of frequency bands for being utilized on the repeater to amplify and forward signals.

In embodiments of the present application, a convenient way is provided to configure or reconfigure the sub-block's center frequency and bandwidth for the repeater by using the auxiliary device to obtain the center frequency and bandwidth of the sub-block available to an operator in a frequency band from a pre-defined LUT based on the location information. In other embodiments of the present application, by prioritizing a plurality of available frequency bands based on corresponding quality scores, most appropriate frequency band(s) can be utilized on the repeater. This may efficiently increase the throughput and coverage area of the repeater.

### BRIEF DESCRIPTION OF THE DRAWINGS

FIG. 1 illustrates a possible network architecture to which the present application is applicable.

FIG. 2 is a block diagram illustrating a communication system according to some embodiments of the present application.

FIG. 3 is a block diagram illustrating an analog FDD repeater according to some embodiments of the present application.

FIG. 4 is a block diagram illustrating a digital FDD repeater according to some embodiments of the present application.

FIG. 5 is a block diagram illustrating a system including a repeater and an auxiliary device communicating with the repeater to set SB configuration of the repeater according to some embodiments of the present application.

FIG. 6 is a flowchart of a SB configuration setting method 100 according to a first embodiment of the present application.

FIG. 7 is a schematic diagram illustrating an example of setting SB configuration according to some embodiments of the present application.

FIG. 8 is a schematic diagram illustrating a look-up table (LUT) according to some embodiments of the present application.

FIG. 9 is a schematic diagram illustrating communication signals between a repeater and an auxiliary device according to some embodiments of the present application.

FIG. 10 is a flowchart of a frequency band selection method according to a second embodiment of the present application.

FIG. 11 is a flow chart of an example of initialization ABS (iABS) according to some embodiments of the present application.

FIG. 12 is a flow chart of an example of periodic ABS (pABS) according to some embodiments of the present application.

FIG. 13 is a flow chart of an example of even-triggered ABS (eABS) according to some embodiments of the present application.

### DETAILED DESCRIPTION

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

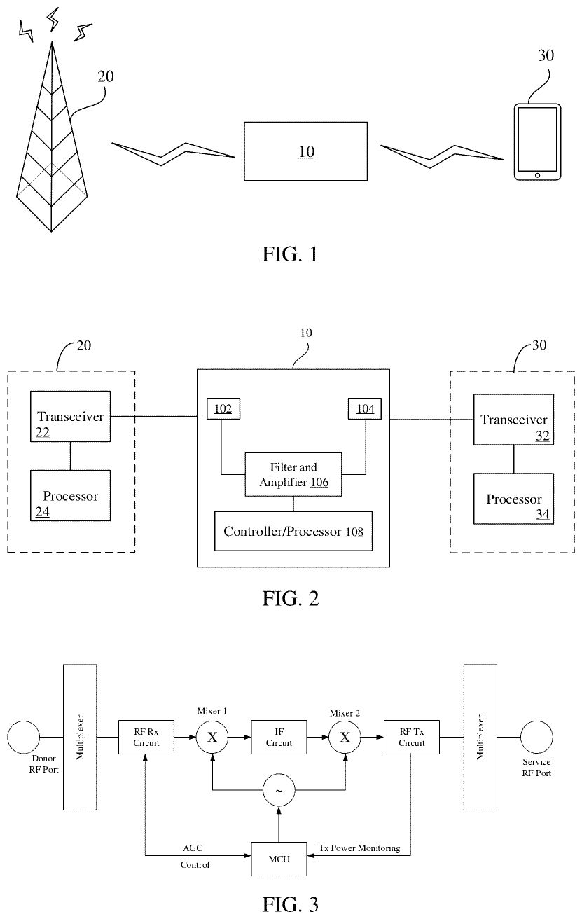

FIG. 1 illustrates a possible network architecture to which the present application is applicable. As shown in FIG. 1, a repeater 10 communicates with a base station (BS) 20 and a user equipment (UE) 30. The repeater 10 is used to repeat or forward signals received either from the base station 20 or the user equipment 30. The repeater can be a signal repeater or relay. The base station 20 is an entity used to transmit or receive signals on the network side, such as a base station in a wireless cellular network. The base station 20 can be, for example, an eNB (or eNodeB) in Long Term Evolution (LTE), or a gNB (or gNodeB) in New Radio (NR), or any network device in future mobile network. The user equipment 30 is a terminal device, which can exchange information and/or data with the wireless cellular network such as a radio access network (RAN). The user equipment 30 would be implemented by a wireless terminal, a user terminal, a terminal device, a mobile terminal (MT), and etc.

As shown in FIG. 1, the repeater 10 is arranged between the base station 20 and the user equipment 30. The repeater 10 can improve the quality of wireless communication by receiving, filtering, amplifying and re-transmitting the signals (more specifically, cellular communication signals) communicated between the base station 20 and the user equipment 30 in both an uplink direction (i.e., from the UE 30 to the base station 20) and a downlink direction (i.e., from the base station 20 to the UE 30). Although illustrated by only one user equipment and only one base station, the repeater 20 may serve more than one user equipments and may repeat signals from more than one base stations and transmit repeated signals to more than one base stations. The repeater 20 may be arranged at a fixed location, such as in a room of a building, or be mounted to a movable object, such as a vehicle.

FIG. 2 is a block diagram illustrating a communication system according to some embodiments of the present application. The communication system includes the afore-mentioned repeater 10, base station 20 and user equipment 30. Connections between devices and device components are shown as connecting lines in FIG. 2. The base station 20 includes a transceiver 22 and a processor 24, which are electrically connected with each other. The user equipment 30 includes a transceiver 32 and a processor 34, which are electrically connected with each other. The repeater 10 includes transceivers 102 and 104, a controller/processor 108, and a filter and amplifier 106 coupled between the transceivers 102 and 104 and the controller/processor 108. The transceiver 32 of the user equipment 30 is configured to transmit a signal, which is received by the repeater 10 using the transceiver 104 and is then forwarded to the base station 20 using the transceiver 102. The user equipment 30 can receive a repeated signal transmitted from the transceiver 104 of the repeater 10. The transceiver 22 of the base station 20 is configured to transmit a signal, which is received by the repeater 10 using the transceivers 102 and is then forwarded to the user equipment 30. The base station 20 can receive a repeated signal transmitted from the transceiver 102 of the repeater 10. In this way, the user equipment 30 communicates with the base station 20 each other through the repeater 10.

Each of the processors 24 and 34 and the controller/processor 108 may be configured to implement proposed functions, procedures and/or methods described in this description. Layers of radio interface protocols may be implemented in the processors 24 and 34 and/or the controller/processor 108. The repeater 10, the base station 20 and the user equipment 30 may each include a memory operatively storing a variety of program and information to operate a connected processor. Each of the transceivers 22 and 32 and the transceivers 102 and 104 is operatively coupled with a connected processor, transmits and/or receives radio signals.

Each of the processors 24 and 34 and the controller/processor 108 may include a general-purpose central processing unit (CPU), an application-specific integrated circuits (ASICs), other chipsets, logic circuits and/or data processing devices. The memory may include a read-only memory (ROM), a random access memory (RAM), a flash memory, a memory card, a storage medium, other storage devices, and/or any combination of the memory and storage devices. Each of the transceivers 22 and 32 and the transceivers 102 and 104 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The transceivers 102 and 104 of the repeater 10 may include a donor antenna and a service antenna. The donor antenna may be mounted externally or internally at a suitable location for receiving downlink signals from the base station 20. The downlink signals are provided to the filter and amplifier 106 to be filtered and amplified based on gain control, and the resulting signals are then provided to the service antenna, which can wirelessly communicate the resulting signals to the user equipment 30. In this way, the user equipment 30 can receive stronger signals from the base station 20.

The service antenna may receive uplink signals from the user equipment 30. The uplink signals are provided to the filter and amplifier 106 to be filtered and amplified based on gain control, and the resulting signals are then provided to the donor antenna, which can wirelessly communicate the resulting signals to the base station 20. In this way, the base station 20 can receive the signals from the user equipment 30 that may be located outside of the coverage area of the base station 20.

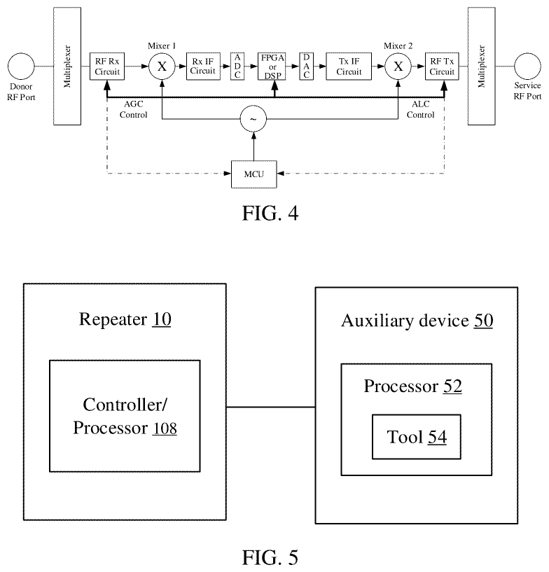

FIG. 3 illustrates an analog frequency division duplex (FDD) repeater, while FIG. 4 illustrates a digital FDD repeater. The invention can be implemented not only by the analog FDD repeater and the digital FDD repeater illustrated in FIG. 3 and FIG. 4 respectively, but also by other types of repeaters, such as an analog time division duplex (TDD) repeater, a digital TDD repeater, or a hybrid repeater with mixed analog and digital circuits. It should be noted that the repeaters shown in FIG. 3 and FIG. 4 are illustrated exemplarily in a DL configuration; however, it is straightforward to derive a UL configuration for the repeaters. As a result, the UL configuration is omitted for simplicity of description.

As shown in FIG. 3 and FIG. 4, the repeater includes a radio frequency (RF) Rx circuit, an RF Tx circuit and a microcontroller (MCU), which may correspond to the controller/processor 108 depicted in FIG. 2. In one circuit configuration, for DL signals, the RF Rx circuit may be coupled to a donor RF port (via a multiplexer) which is used to connect to a donor antenna for receiving downlink signals from the base station, and the RF Tx circuit may be coupled to a service RF port (via a multiplexer) which is used to connect to a service antenna for transmitting the downlink signals to the user equipment. In another circuit configuration, for UL signals, the RF Rx circuit may be coupled to the service antenna for receiving uplink signals from the user equipment, and the RF Tx circuit may be coupled to the donor antenna for transmitting the uplink signals to the base station. The MCU coupled to the RF Rx circuit and the RF Tx circuit is configured to control Rx Gain of the RF Rx circuit and Tx Gain of the RF Tx circuit. The total gain of the repeater is considered as a sum of Rx Gain and Tx Gain. The control of Rx Gain is achieved by AGC (Auto Gain Control), while the control of Tx Gain is by ALC (Auto Level Control). For the analog repeater depicted in FIG. 3, the Tx Gain is usually fixed and thus, the control of the total gain of the analog repeater is mainly achieved by controlling the Rx Gain by AGC. For the digital repeater depicted in FIG. 4, both the Rx Gain and the Tx gain are configurable, and thus the control of the total gain of the digital repeater is achieved by controlling the Rx Gain by AGC and controlling the Tx Gain by ALC. Synchronization of the two control loops is necessary for the digital repeater.

As depicted in FIG. 3, the analog repeater includes an intermediate frequency (IF) circuit used to generate IF signals, and two mixers (i.e., Mixer 1 and Mixer 2) for frequency mixing with carrier frequency, for example. Different from the analog repeater depicted in FIG. 3, instead of the IF circuit arranged between the two mixers, the digital repeater depicted in FIG. 4 includes a Rx IF circuit, an analog-to-digital circuit (ADC), a field programmable gate array (FPGA) or digital signal processor (DSP) chip, a digital-to-analog circuit (DAC) and a Tx IF circuit located between the two mixers. The digital repeater performs digital signal processing by using the afore-mentioned circuit elements.

The present application aims at providing a convenient way to set a sub-block (SB) configuration for a repeater, in which the center frequency and bandwidth of a sub-block available to an operator in a frequency band (e.g., n78 in 5G NR) are configured in the SB configuration. This would be beneficial whenever the SB configuration of the repeater needs to be configured or reconfigured. For example, a user or technician may have to reconfigure the repeater to allocate a correct center frequency and bandwidth of the sub-block based on the installation location of the repeater, particularly when the installation location of the repeater is moved to a different state or country. The invention also facilitates a global use of the repeater since the SB configuration can be set based on the installation location (e.g., a state or country) of the repeater.

FIG. 5 is a block diagram illustrating a system including a repeater and an auxiliary device communicating with the repeater to set SB configuration of the repeater according to some embodiments of the present application. Referring to FIG. 5, the repeater 10 includes the controller/processor 108 as mentioned above. With the help of the controller/processor 108, the repeater 10 can amplify and forward signals of a sub-block based on the center frequency and bandwidth of the sub-block configured in the SB configuration. The auxiliary device 50 can communicate with the repeater 10 via various communication technologies. The auxiliary device 50 includes a processor 52, which can execute an application program, APP or tool 54 to set the SB configuration for the repeater 10. Specifically, the center frequency and bandwidth of a sub-block available to an operator in a frequency band are set based on the installation location by referring to a pre-defined look-up table (LUT). The auxiliary device 50 can be a handset/pad, a smartphone or a tablet that is able to connect to a same mobile network as the repeater 10 so as to obtain location information (e.g., a state or country code) and operator information through the mobile network for setting the SB configuration. The auxiliary device 50 can also be a personal computer (PC) or a notebook (NB) equipped with a cellular modem and is able to connect to a same mobile network as the repeater 10.

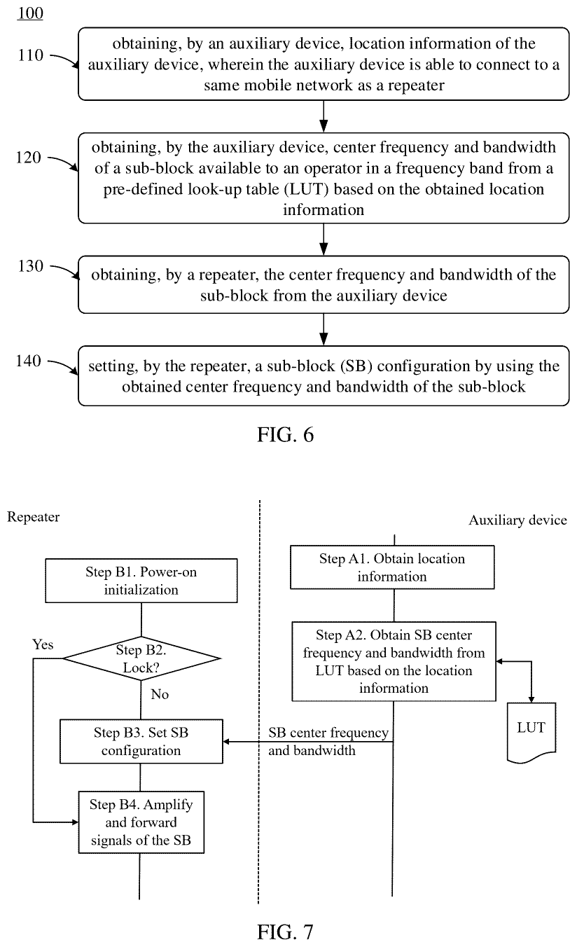

FIG. 6 is a flowchart of a SB configuration setting method 100 according to a first embodiment of the present application. FIG. 7 is a schematic diagram illustrating an example of setting SB configuration according to some embodiments of the present application. Referring to FIGS. 6 and 7, the SB configuration setting method 100 includes the following steps.

In Step 110, the auxiliary device obtains location information (e.g., a state or country code) of the auxiliary device (see also Step A1 of FIG. 6). The location information may be obtained from a mobile network the auxiliary device is connected to. The auxiliary device is able to connect to a same mobile network as the repeater. Since the auxiliary device and the repeater are located at a same location (e.g., a same state or country), the location information of the auxiliary device can serve as the installation location of the repeater. In an example, the location information of the auxiliary device may be obtained from Public Land Mobile Network (PLMN) identifier (ID), which carries Mobile Country Code (MCC) identifying which country the auxiliary device is located. The PLMN ID also includes Mobile Network Code (MNC), which identifies an operator providing the mobile network. The MNC obtained by the auxiliary device would indicate a mobile network that is the same as the mobile network the repeater is connected to in the case that the auxiliary device and the repeater connect to the same mobile network.

In Step 120, the auxiliary device obtains center frequency and bandwidth of a sub-block available to an operator in a frequency band from a pre-defined look-up table (LUT) based on the obtained location information (see also Step A2 of FIG. 6). The pre-defined LUT stores the center frequency and bandwidth of a sub-block that the operator can apply in a specific country. Therefore, by referring to the pre-defined LUT, the auxiliary device can use the location information of the auxiliary device to get the center frequency and bandwidth of the sub-block that the operator can apply in that location. The auxiliary device may query a remote site (e.g., a cloud server) storing the pre-defined LUT to obtain the information of the sub-block. Alternatively, the auxiliary device may download the pre-defined LUT from the remote site and get the information of the sub-block from the downloaded pre-defined LUT.

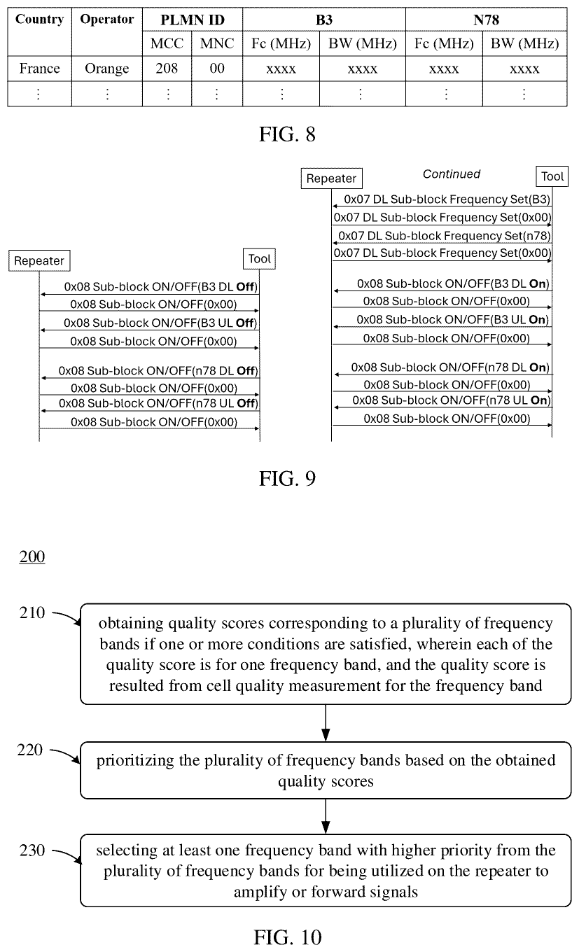

FIG. 8 shows an example of the pre-defined LUT. The data listed in the LUT may include country name (e.g., “France”), operator name (e.g., “Orange”), MMC (e.g., “208”) corresponding to the country name, MNC (e.g., “00”) corresponding to the operator name, center frequency “Fc” and bandwidth “BW” of a sub-block in a specific frequency bands (e.g., Band n78 or Band B3). One or more frequency bands may be provided in the LUT.

Referring to FIG. 8, for an illustrated example, the auxiliary device obtains PLMN ID including MCC “208” and MNC “00” from a mobile network the auxiliary device is connected to. Then, by referring to the pre-defined LUT, the auxiliary device can obtain the central frequency and bandwidth of the sub-block that the operator corresponding to MNC “00” can apply in Band B78 in the country “France”. Also, the auxiliary device can obtain the central frequency and bandwidth of the sub-block of Band 3 from the pre-defined LUT.

In some scenarios, the repeater may be installed in a location, where there is no donor base station (BS) signal at all. In this case, the tool cannot obtain the PLMN ID from the auxiliary device near the repeater. To solve this, the user or technician may go to somewhere there is strong enough BS signal and perform “Network Information Get” to get the PLMN ID and obtain the central frequency and bandwidth of the sub-block from the pre-defined LUT based on the PLMN ID.

In some embodiments, the tool of the auxiliary device may provide a manual selection list for user selection of operator information and the location information. For example, the tool may provide an interface for the user or technician to select a country name (e.g., “France”) and an operator name (e.g., “Orange”). By using the selected country name and operator name, the tool can query the pre-defined LUT shown in FIG. 8 to obtain corresponding sub-block information.

In some embodiments, the pre-defined LUT, either in a remote storage or in a local storage can be updated for spectrum re-farming or other changes. For example, the auxiliary device may obtain the pre-defined LUT from a remote storage, store the pre-defined LUT in a local storage and update the pre-defined LUT stored in the local storage.

In Step 130, the repeater obtains the center frequency and bandwidth of the sub-block from the auxiliary device. In this step, once the auxiliary device obtains the center frequency and bandwidth of the sub-block from the pre-defined LUT, the auxiliary device transmits the information of the sub-block to the repeater. With this information, the repeater can set a SB configuration (i.e., the center frequency and bandwidth of the sub-block), and later amplify and forward the signals of the sub-block based on the SB configuration.

In Step 140, the repeater sets a sub-block (SB) configuration by using the obtained center frequency and bandwidth of the sub-block (see also Step B3 of FIG. 7). In some embodiments, the repeater may set the SB configuration in response to a control command transmitted from the auxiliary device.

FIG. 9 shows communication signals between the repeater and the tool installed on the auxiliary device to set the center frequency and bandwidth of the sub-block (i.e., the SB configuration). In an illustrated example shown in FIG. 9, at the beginning, the tool asks the repeater to turn off B3 downlink (DL) and uplink (UL) operations and turn off n78 DL and UL operations. Then, the tool transmits control commands to the repeater, and based on the control commands, the repeater sets the center frequency and bandwidth of the sub-block of Band B3 and the center frequency and bandwidth of the sub-block of Band n78. The values of the center frequency and bandwidth of the sub-blocks of Band B3 and n78 can be provided together with the control commands. Finally, the tool asks the repeater to turn on B3 DL and UL operations and turn on n78 DL and UL operations.

After the SB configuration is set, the repeater can amplify and forward signals based on the center frequency and bandwidth of the sub-block configured in the SB configuration (see Step B4 of FIG. 7).

In some embodiments, after power-on initialization is performed on the repeater (see Step B1 of FIG. 7) and before setting the SB configuration, the repeater may determine whether a SB configuration setting function is locked (see Step B2 of FIG. 7). The function to set the SB configuration can be locked in order to strengthen the security, particularly when the SB configuration has been set. The lock function is to request the repeater to reject all SB re-configuration requests from un-authorized users. The SB configuration is allowed to be set or reset only when the SB configuration setting function is not locked or unlocked. For example, the SB configuration setting function is not locked before a user or technician finishes deployment of the repeater. After the deployment of the repeater, the SB configuration is set and the SB configuration setting function is locked.

In some embodiments, only authorized users can reset a locked repeater to unlocked through the same or a different tool. Examples of the authentication can be account/password, key combination, biometrics, and so on. The auxiliary device may communicate with the repeater to unlock the SB configuration setting function. The SB configuration setting function can be unlocked only when the auxiliary device is authenticated. The authentication of a user, a technician or a device can be performed on the auxiliary device itself or both on the auxiliary device and the repeater.

In some embodiments, if the repeater determines that the SB configuration setting function is locked, the repeater may apply the center frequency and bandwidth of the sub-block configured in a stored SB configuration (which can also be a default SB configuration) (see Step B4 of FIG. 7). Specifically, when the SB configuration setting function is locked, it means the SB configuration has been set. Therefore, the repeater can apply the SB configuration that has been stored. If the repeater determines that the SB configuration setting function is not locked, it means the SB configuration has not been set, and the process may go to Step B3 of FIG. 7 to set the SB configuration.

The present application provides the SB configuration setting method 100 as described above. In this SB configuration setting method 100, the auxiliary device obtains center frequency and bandwidth of a sub-block available to an operator in a frequency band from a pre-defined LUT based on the location information, and the obtained center frequency and bandwidth of the sub-block are provided for the repeater to set the SB configuration. In this way, this application provides a convenient way to configure or reconfigure the sub-block's center frequency and bandwidth for the repeater.

FIG. 10 is a flowchart of a frequency band selection method 200 according to a second embodiment of the present application. The frequency band selection 200 is applied to a repeater, and the exemplary structure of the repeater may be referred to FIGS. 2 to 4. The method 200 includes the following steps.

In Step 210, the repeater obtains quality scores corresponding to a plurality of frequency bands if one or more conditions are satisfied. Specifically, each of the quality score is for one frequency band, and the quality score is resulted from cell quality measurement for the frequency band. In this step, in order to select one or more appropriate frequency bands for the repeater to work with, the quality score for each frequency band is obtained. The quality score corresponding to the frequency band may be obtained by performing the cell quality measurement for the frequency band for each time the frequency band selection is needed. Alternatively, for each time the cell quality measurement is performed, the quality score may be stored. Then, whenever the frequency band selection is needed, the repeater obtains the quality score corresponding to the frequency band from historical quality score data stored in a storage. It is also possible to use the quality scores obtained from the cell quality measurement performed instantly and from the historical quality score data.

In some embodiments, a scoring object for calculating the quality score resulted from the cell quality measurement includes at least one of the following: frequency values of the frequency band (e.g., which is a high band, low band or middle band), total sub-block (SB) bandwidth that is available to an operator within one frequency band, total downlink (DL) output power of the repeater, and DL signal quality, but the invention is not limited thereto. The DL signal quality may include at least one of the following: Reference Signal Received Power (RSRP), Reference Signal Received Quality (RSRQ) and Singal to Interference Noise Ratio (SINR).

In some embodiments, in addition to the cell quality measurement, the quality score for the frequency band may be further calculated based on uplink (UL) signal condition. A reason to take the UL signal condition into consideration is mainly because a user equipment (UE) in the repeater coverage area may not support this frequency band. The UL signal condition may include at least one of the following: UL utilization ratio and UL signal quality. The UL utilization ratio indicates a percentage of user utilization of the frequency band for a certain time period. If the UL utilization ratio is low, it means that seldom user activities left in that band, and this would lead to a low quality score. Examples of the UL signal quality include UL Received Signal Strength Indicator (RSSI) received by the repeater. If the UL RSSI is too strong (which may cause variable gain) or too weak (which means poor signal quality), a corresponding quality score should not be high. The UL quality scores may be obtained with the co-working of users of the user equipments. For example, the user may manipulate a specific application program or APP on the handset to assist the repeater in obtaining the UL quality scores.

It is also noted that different scoring objects can take appropriate weights, and for the scoring objects that are not supported or available in some scenarios, the corresponding value may be set to 0 or a minimal value.

In Step 220, the plurality of frequency bands are prioritized based on the obtained quality scores. For example, each frequency band represents signal quality as a quality score. High quality scores mean the higher priority for selection of the band. The quality scores may be ranked from high to low. The frequency bands with higher quality scores are deemed as appropriate frequency bands for the selection. It some quality scores obtained from the cell quality measurement performed instantly and some from the historical quality score data within a certain period of time, these quality scores may be used together to determine the appropriate frequency bands.

In Step 230, at least one frequency band with higher priority is selected from the plurality of frequency bands for being utilized on the repeater to amplify and forward signals. In this step, one or more frequency bands may be utilized simultaneously on the repeater, and therefore one or more frequency bands with higher priority may be selected. The repeater amplifies and forwards the signals on the selected frequency band(s).

The followings give an example of formula to calculate the quality score based on cell quality measurement. Cell quality measurements include, but are not limited to, DL RSSI, RSPR, RSRQ, SINR, SB center frequency and SB bandwidth. In order to quantify the quality, the corresponding Quality Score is calculated as follows. It is obvious that the first term in the Quality Score formula is considered from the perspective of coverage, while the second term is considered from the perspective of throughput. A higher Quality Score means better cell quality.

$$Quality Score = \frac{{w}_{1} \times {S}_{1} + {w}_{5} \times {S}_{5}}{2} + \frac{{w}_{2} \times avg ( \sum ( {S}_{2} \times {S}_{3} ) ) + {w}_{3} \times avg ( \sum ( {S}_{4} ) ) + {w}_{6} \times {S}_{6}}{H ( avg ( \sum ( {S}_{2} \times {S}_{3} ) ) - 0.5 ) + H ( avg ( \sum ( {S}_{4} ) ) - 0.5 ) + 1 )} ,$$

where w₁, w₂, w₃, w₅ and w₆ are the weights defined for different usage scenarios of the repeaters. In addition, H(x) is a Heaviside function, which value is 1 when x is positive and is 0 when x is negative. The avg(Σ(x)) function represents the average of all x values that are not 0. When all x values are 0, avg(Σ(x))=0. Taking avg(Σ(S₄)) as an example, if there are 3 sub-blocks in a frequency band and their S₄ values are 4, 0 and 3, respectively, then avg(Σ(S₄))=3.5. For another example, if the S₄ values of the 3 sub-blocks are all 0, then avg(Σ(S₄))=0.

| Scenario | w₁ | w₅ | w₂ | w₃ | w₆ |
|---|---|---|---|---|---|
| Throughput-oriented (TO) | 0.3 | 0.3 | 0.7 | 0.7 | 0.7 |
| Coverage-oriented (CO) | 0.7 | 0.7 | 0.3 | 0.3 | 0.3 |
| Balanced (BAL) | 0.5 | 0.5 | 0.5 | 0.5 | 0.5 |

Moreover, S₁, S₂, S₃, S₄, S₅ and S₆ are defined as follows.

| Total DL Output Power* of All Sub-blocks (dBm) | S₁ | Note |
|---|---|---|
| ≥Max O/P Power** −3 dB | 2 | Poor, due to ALC |
| Max O/P Power −9 dB≤ . . . <Max O/P Power −3 dB | 5 | Excellent |
| Max O/P Power −15 dB≤ . . . <Max O/P Power −9 dB | 4 | Good |
| Max O/P Power −21 dB≤ . . . <Max O/P Power −15 dB | 3 | Fair |
| Max O/P Power −27 dB≤ . . . <Max O/P Power −21 dB | 2 | Poor |
| Max O/P Power −27 dB< | 1 | Bad |

*For each sub-block, the corresponding DL output power is calculated as its RSSI + Set DL Gain.
**Max O/P Power is the sum of the maximum O/P power set for all sub-blocks.

| Sub-block RSRP (dBm) | S₂ | Note |
|---|---|---|
| ≥−100 | 1 | Valid RSRQ |
| <−100 | 0 | Invalid RSRQ |
| Not Available | 0 | |

| Sub-block RSRQ (dB) | S₃ | Note |
|---|---|---|
| ≥−8 | 5 | Excellent |
| −12≤. . . <−8 | 4 | Good |
| −15≤ . . . <−12 | 3 | Fair |
| −20≤ . . . <−15 | 2 | Poor |
| <−20 | 1 | Bad |
| Not Available | 0 | |
| Sub-block SINR (dB) | S₄ | Note |
| ≥27 | 5 | Excellent |
| 20≤ . . . <27 | 4 | Good |
| 13≤ . . . <20 | 3 | Fair |
| 0≤ . . . <13 | 2 | Poor |
| <0 | 1 | Bad |
| Not Available | 0 | |

| 1^{st}* Sub-block Center Frequency (MHz) | S₅ | Note |
|---|---|---|
| <1000 | 5 | Low Band |
| 1000≤ . . . <2000 | 4 | Middle Band |
| 2000≤ . . . <4000 | 3 | High Band |
| 4000≤ . . . <8000 | 2 | Very High Band |
| ≥8000 | 1 | Super High Band |

*For multiple sub-blocks within a frequency band, they SHALL have the same S₅ values.

| Total Bandwidth of All Sub-blocks (MHz) | S₆ | Note |
|---|---|---|
| ≥40 | 5 | Intra CA/5G NR |
| 20≤ . . . <40 | 4 | Intra CA/5G NR |
| 10≤ . . . <20 | 3 | LTE or Before |
| 55≤ . . . <10 | 2 | LTE or Before |
| <5 | 1 | LTE or Before |

In the followings, ABS, standing for Auto Band Selection, means that the repeater can automatically select the most appropriate frequency band(s) for the installation site when the repeater is turned on or in operation. ABS procedures may be only performed when the repeater is operating normally (no alarm). When performing ABS on a band, the corresponding DL and UL high-power amplifier module (HPA) may have to be turned Off first to minimize the impact of echo interference.

Three illustrated examples of ABS procedures are defined as follows:
(i) Initialization ABS (iABS): only perform when the repeater is turned on.
(ii) Periodic ABS (pABS): only perform when the set timer times out and UL is mute.
(iii) Event-triggered ABS (eABS): only perform when the set criteria are met.

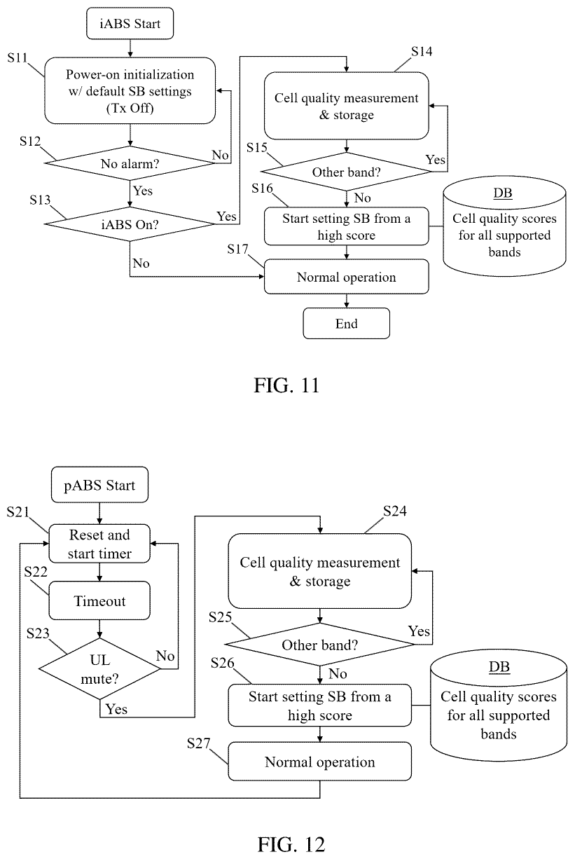

FIG. 11 is a flow chart of an example of initialization ABS (iABS) according to some embodiments of the present application. This is an example of Auto Band Selection (ABS), which is performed only when the repeater is turned on. The user data for iABS may include an indication of whether the band selection function is configured on (i.e., user configurable On/Off), and (historical) cell quality scores for all supported bands, which may be stored in a database DB and may be shared by other ABS procedures such as pABS and eABS mentioned above. Referring to FIG. 11, power-on initialization is first performed on the repeater in Step S11. The power-on initialization is performed using default SB settings with all transmissions (Tx) turned off. The process then checks whether an alarm exists in Step S12 and whether the band selection function is configured on in Step S13. If no alarm exists and the band selection function is configured on, the process continues the Auto Band Selection. If any alarm exists, the process goes to Step S11 to try power-on initialization again. If the band selection function is configured off, the repeater perform normal operations in Step S17. In Step S14, cell quality measurement is performed and the results (the quality score corresponding to a given frequency band) are stored in a storage. For iABS, DL quality scores are mandatory while UL quality scores are optional for the band selection. The UL quality scores may be obtained with the co-working of users. For example, the user manipulates a specific APP on the handset during the iABS procedure to assist the repeater in obtaining UL quality scores. In Step S15, the process checks whether the DL quality scores and/or the UL quality scores are calculated for all available frequency bands. If any calculation is needed for other bands, the process goes to Step S14; otherwise, if all necessary calculations are done, the process goes to Step S16. In Step S16, all the involved frequency bands are prioritized based on the quality scores, and sub-block(s) of the frequency band(s) with higher quality score is/are set for being utilized by the repeater to amplify and forward corresponding signals. In this step, some historical quality score data from the database DB may be used together in determining the priority of the frequency bands. After the sub-block(s) of the selected frequency band(s) is/are determined, the repeater performs normal operation (see Step S17) with the set sub-block(s).

FIG. 12 is a flow chart of an example of periodic ABS (pABS) according to some embodiments of the present application. This is an example of ABS, which is performed periodically. The user data for pABS may include a set timeout length of a timer, an indication of whether the band selection function is configured on (i.e., user configurable On/Off), and (historical) cell quality scores for all supported bands, which may be stored in a database DB and may be shared by other ABS procedures such as iABS and eABS mentioned above. Referring to FIG. 11, the process set/reset and start the timer in Step S21. If timeout (see Step S22), the process checks whether UL is mute in Step S23. Only if timeout and the UL is muted, the process continues the Auto Band Selection. If the UL is not muted, the process goes to Step S21 to reset the timer. Since pABS interrupts the normal operation of the repeater, it may only be performed when the UL is muted. In Step S24, cell quality measurement is performed and the results (the quality score corresponding to a given frequency band) are stored in a storage. pABS can also be used to periodically update cell quality measurements during repeater operation. In Step S25, the process checks whether the DL quality scores are calculated for all available frequency bands. If any calculation is needed for other bands, the process goes to Step S24; otherwise, if all necessary calculations are done, the process goes to Step S26. In Step S26, all the involved frequency bands are prioritized based on the quality scores, and sub-block(s) of the frequency band(s) with higher quality score is/are set for being utilized by the repeater to amplify and forward corresponding signals. In this step, some historical quality score data from the database DB may be used together in determining the priority of the frequency bands. After the sub-block(s) of the selected frequency band(s) is/are determined, the repeater performs normal operation (see Step S27) with the set sub-block(s).

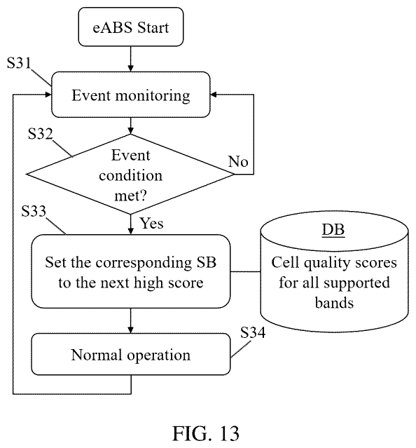

FIG. 13 is a flow chart of an example of event-triggered ABS (eABS) according to some embodiments of the present application. This is an example of ABS, which is event-triggered. The user data for eABS may include an indication of whether the band selection function is configured on (i.e., user configurable On/Off), current cell quality scores for being used for band re-selection, and triggered events, which may include: (1) locked cell quality within a pre-defined period is still lower than another un-selected band, (2) UL utilization ratio or UL signal quality of the locked cell is still low within a pre-defined period, and (3) user demand. Referring to FIG. 11, event monitoring is performed on the repeater in Step S31. The process checks whether a certain event condition is met in Step S32. If no, the process goes back to Step S31. If yes, the process goes to Step S33. In Step S33, the process determines a next high quality score from current cell quality scores, which may be retrieved directly from the database DB. The current cell quality scores are scores of frequency bands except to a previously utilized frequency band. In this step, sub-block(s) of the frequency band(s) with next high quality score(s) is/are set for being utilized by the repeater to amplify and forward corresponding signals. After the sub-block(s) is/are determined, the repeater performs normal operation (see Step S34) with the set sub-block(s). Ping-pong may occur when there are not enough good cells to choose from, for example, in a scenario of regional power outage. If concern, the eABS may be stopped after a few times until the user restarts the repeater.

Auto Sub-block Configuration (ASC) means that the repeater's SBs are set through a tool. The ASC is performed based on repeater installation location and through the PLMN ID obtained by an auxiliary device. It should be noted that if ASC is required and enabled, it should be performed before ABS. This is because sub-block(s) available to an operator in a frequency band has/have to be determined first in the ASC and then the ABS can select most appropriate frequency bands(s) and corresponding sub-block(s). ABS scoring of a certain band requires the sub-block(s) of the band to be configured first.

There may have two types of RFFE (Radio Frequency Front-End) designs for the repeater to support ABS for all supported bands, that is, dedicated RF circuits (for example, 4 RF circuits support 4 bands) and shared RF circuits (for example, 2 RF circuits support choosing 2 of 4 bands (C2f4)). For the shared RF circuits, implementations may include, but not limited to an RF switch-based type, an RF multiplexer-based type, and combinations of the above two.

The present application provides the frequency band selection method 200 as described above. In this frequency band selection method 200, the quality scores corresponding to a plurality of frequency bands, resulted from cell quality measurement, are obtained, the plurality of frequency bands are prioritized based on the obtained quality scores, and at least one frequency band with higher priority is selected from the plurality of frequency bands for being utilized on the repeater to amplify and forward signals. In this way, most appropriate frequency band(s) can be utilized on the repeater. This may efficiently increase the throughput and coverage area of the repeater.

The embodiment of the present application further provides a repeater, which includes a Rx circuit; a Tx circuit; and at least one processor, coupled to the Rx circuit and the Tx circuit, the at least one processor being configured to execute corresponding processes implemented in each of the methods of the embodiments of the present application. For brevity, details will not be described herein again.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘including’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A method of setting sub-block (SB) configuration for a repeater, comprising:
obtaining, by an auxiliary device, location information of the auxiliary device, wherein the auxiliary device is able to connect to a same mobile network as a repeater;
obtaining, by the auxiliary device, center frequency and bandwidth of a sub-block available to an operator in a frequency band from a pre-defined look-up table (LUT) based on the obtained location information;
obtaining, by the repeater, the center frequency and bandwidth of the sub-block from the auxiliary device; and
setting, by the repeater, a sub-block (SB) configuration by using the obtained center frequency and bandwidth of the sub-block.

2. The method according to claim 1, further comprising:
amplifying and forwarding signals by the repeater based on the center frequency and bandwidth of the sub-block configured in the SB configuration.

3. The method according to claim 1, wherein the location information of the auxiliary device is obtained from Public Land Mobile Network (PLMN) identifier (ID), which carries Mobile Country Code (MCC) identifying which country the auxiliary device is located.

4. The method according to claim 1, wherein before the step of setting, by the repeater, the SB configuration by using the obtained center frequency and bandwidth of the sub-block, the method further comprises:
determining, by the repeater, whether a SB configuration setting function is locked,
wherein the SB configuration is allowed to be set or reset only when the SB configuration setting function is not locked or unlocked.

5. The method according to claim 4, further comprising:
if the SB configuration setting function is locked, applying, by the repeater, the center frequency and bandwidth of the sub-block configured in a stored SB configuration.

6. The method according to claim 4, further comprising:
communicating, by the auxiliary device, with the repeater to unlock the SB configuration setting function,
wherein the SB configuration setting function can be unlocked only when the auxiliary device is authenticated.

7. The method according to claim 1, wherein before the step of setting, by the repeater, the SB configuration by using the obtained center frequency and bandwidth of the sub-block, the method further comprises:
transmitting, by the auxiliary device, a control command to the repeater to set the SB configuration of the repeater.

8. The method according to claim 1, further comprising:
providing a manual selection list for user selection of operator information and the location information.

9. The method according to claim 1, further comprising:
obtaining, by the auxiliary device, the pre-defined LUT from a remote storage;
storing, by the auxiliary device, the pre-defined LUT in a local storage; and
updating, by the auxiliary device, the pre-defined LUT stored in the local storage.

10. A system for setting sub-block (SB) configuration, comprising:
an auxiliary device, comprising a memory and a first processor coupled to the memory, the first processor being configured to:
obtain location information of the auxiliary device, wherein the auxiliary device is able to connect to a same mobile network as a repeater; and
obtain center frequency and bandwidth of a sub-block available to an operator in a frequency band from a pre-defined look-up table (LUT) based on the obtained location information,
the repeater, comprising a Rx circuit, a Tx circuit, and a second processor, coupled to the Rx circuit and the Tx circuit, the second processor being configured to:
obtain the center frequency and bandwidth of the sub-block from the auxiliary device; and
set a sub-block (SB) configuration by using the obtained center frequency and bandwidth of the sub-block.

11. A method of frequency band selection by a repeater, comprising:
obtaining quality scores corresponding to a plurality of frequency bands if one or more conditions are satisfied, wherein each of the quality score is for one frequency band, and the quality score is resulted from cell quality measurement for the frequency band;
prioritizing the plurality of frequency bands based on the obtained quality scores; and
selecting at least one frequency band with higher priority from the plurality of frequency bands for being utilized on the repeater to amplify and forward signals.

12. The method according to claim 11, wherein the quality scores obtaining step comprises:
performing the cell quality measurement for the frequency band to obtain the quality score corresponding to the frequency band; or
obtaining the quality score corresponding to the frequency band from historical quality score data stored in a storage.

13. The method according to claim 11, wherein a scoring object for calculating the quality score resulted from the cell quality measurement comprises at least one of the following: frequency values of the frequency band, total sub-block (SB) bandwidth, total downlink (DL) output power and DL signal quality.

14. The method according to claim 11, wherein in addition to the cell quality measurement, the quality score for the frequency band is further calculated based on uplink (UL) signal condition.

15. The method according to claim 14, wherein the UL signal condition comprises at least one of the following: UL utilization ratio and UL signal quality.

16. The method according to claim 11, wherein the one or more conditions comprises when the repeater is powered on.

17. The method according to claim 16, wherein the one or more conditions further comprises at least one of the following: no alarm exists and a frequency band selection function is configured on.

18. The method according to claim 11, wherein the one or more conditions comprises a set timer times out and UL is mute.

19. The method according to claim 11, wherein the one or more conditions comprises an event condition is met.

20. A repeater, comprising:
a Rx circuit;
a Tx circuit; and
at least one processor, coupled to the Rx circuit and the Tx circuit, the at least one processor being configured to execute the method according to claim 11.
